(19) United States
(12) Patent Application Publication
(10) Pub. No.: US 2014/0019207 A1
(43) Pub. Date: Jan. 16, 2014

(54) INTERACTIVE IN-MEMORY BASED SALES FORECASTING

(71) Applicants: Stefan Kraus, Bruchsal (DE); S M Fazlul Hoque, Mannheim (DE); Aravinda Pantar, Bangalore (IN); Guenter Wilmer, Mannheim (DE); Ruediger Eichin, Heidelberg (DE); Jan Matthes, Darmstadt (DE); Kiran Biradarpatil, Belgaum (IN)

(72) Inventors: Stefan Kraus, Bruchsal (DE); S M Fazlul Hoque, Mannheim (DE); Aravinda Pantar, Bangalore (IN); Guenter Wilmer, Mannheim (DE); Ruediger Eichin, Heidelberg (DE); Jan Matthes, Darmstadt (DE); Kiran Biradarpatil, Belgaum (IN)

(73) Assignee: SAP AG, Walldorf (DE)

(21) Appl. No.: 13/546,690

(22) Filed: Jul. 11, 2012

(51) Int. Cl. G06Q 10/04

(52) U.S. Cl. 705/7.31

(57) ABSTRACT

A system and method provide for a sales forecasting application implemented on a user terminal. The sales forecasting system uses integrated predictive and statistical methods to evaluate the reliability of the forecast. The sales forecasting system may perform a statistical analysis to derive a sequence for the influencing attributes, driving sales success in the past, and display the attributes to an end user in a specific sequence. The sales forecasting system may further be implemented through a sequences of stages, including a pipeline analysis stage where the system understands the situation and any possible risks, an analysis stage where the system may analyze past or external influences, and an application stage where the forecasting system applies the insights to a current pipeline and provides a determined simulation.

### BACKGROUND INFORMATION

Any overall sales process may include initial projections that can provide information about future and projected sales. Such sales projections provide information about expected sales numbers for a shorter timeframe (e.g. quarters) and beyond (e.g. year-end, rolling 12 months). Sales projection itself is a repetitive process, which involves multiple roles, such as a sales manager who is responsible to reach sales targets and deliver the sales projection. The outcome of the projections is used for multiple purposes, such as profitability planning, capacity planning, or decisions on marketing campaigns and related activities. Therefore, sales forecasting represents a critical process where improvements in accuracy and robustness result in tangible benefits for the company.

Existing solutions often use only a limited set of data, such as addressing only opportunities, or don't provide access to current data. Many current sales projecting implementations don't consider work that may be based on replicated information or is based upon historic information. These solutions provide limited use of analytics in providing their sales forecasts. As a consequence of these shortcomings, sales managers often use spreadsheets or other similar programs as a central tool of their forecasting process. Based on replicated information about the current opportunity pipeline, sales managers often rely on their gut feeling when they analyze and adjust the bottom-up view from the sales team.

Thus, there remains a need in the art for a system that allows users to have access to a more reliable sales forecasting system that can utilize the totality of available resource and opportunity data. There also remains a need in the art for a system to combine in-memory technology with a broader end-to-end processes view of an integrated business process platform, to provide a more detailed sales forecasting system.

### SUMMARY

A system and method are described herein that provide for a sales forecasting application implemented on a user terminal. The sales forecasting system uses integrated predictive and statistical methods to evaluate the reliability of the forecast. The sales forecasting system may perform a statistical analysis to derive a sequence for the influencing attributes, driving sales success in the past, and display the attributes to an end user in a specific sequence. The sales forecasting system may further be implemented through a sequence of stages, including a pipeline analysis stage where the system understands the situation and any possible risks, an analysis stage where the system may analyze past or external influences, and an application stage where the forecasting system applies the insights to a current pipeline and provides a determined simulation.

In particular, the exemplary embodiments and/or exemplary methods are directed to a system and method for providing interactive sales forecasts to improve the reliability of sales forecasting. This system and method includes at least one user terminal displaying a user interface, where the sales forecasting system is displayed on the user interface. The system and method also include an in-memory database that stores historical data and opportunity data which may be extracted and loaded to the in-memory database from other subsystem. The system may include a process, or other means in which a sales forecasting application is executed. The sales forecasting application can be configured to retrieve the historical data from the in-memory database and update a current pipeline based on the derived confidence information. The current pipeline can be displayed over a designated time period, with the designated time period being one of a month, a sales quarter, multiple sales quarters, or a year.

The sales forecasting application may also determine a list of influencing attributes based on the current pipeline and retrieved historical data, where the influencing attributes are sorted by statistical relevance by various algorithms used by the application. This is further described in co-pending U.S. patent application Ser. No. 13/546,157. Some of the influencing attributes may be calculated instantaneously after the historical data is retrieved from the in-memory database. The application may also display the sorted influencing attributes in the user interface, where upon selection of an influencing attribute by a user, a list of attribute values, making up a business segment, can be generated from the selected influencing attribute. A user can select at least one of the attribute values of the sorted influencing attributes to compare. The selected attribute values can be displayed graphically for further analysis. For the generated business segments, the sales success and related confidence categories can be determined.

The system and method may generate and update at least one opportunity pipeline, including the confidence categories for display in the user interface. The determination of the confidence categories is further described in co-pending U.S. patent application Ser. No. 13/546,357. The generated opportunity pipelines may be a function of any opportunity data and the influencing attributes previously displayed by the forecasting system. One of the generated opportunity pipelines may be an expected value opportunity pipeline, while another may be a weighted opportunity pipeline.

An advanced business application programming (ABAP) system can also be used to access the stored historical and opportunity data from the in-memory database if needed. The sales forecasting application can also be implemented on an integrated business platform.

### BRIEF DESCRIPTION OF THE DRAWINGS

FIG. 1 is a diagram of a sales forecasting application displayed on a user terminal according to an embodiment.

FIG. 2 is a diagram of the architecture of a sales forecasting system according to an embodiment.

FIG. 3 is a flow diagram of the process stages for the sales forecasting application according to an embodiment.

FIG. 4 is a diagram of the pipeline analysis stage of the sales forecasting application as displayed on a user interface according to an embodiment.

FIG. 5 is a diagram of the impact analysis stage of the sales forecasting application as displayed on a user interface according to an embodiment.

### DETAILED DESCRIPTION

The subject matter will now be described in detail for specific preferred embodiments, it being understood that these embodiments are intended only as illustrative examples and is not to be limited thereto these embodiments.

Previous implementations that provided sales forecasts and projections concentrated on the use of data silos and had limited use of analytics or the measuring and evaluating of historical data, which put limitations on any projected sales forecasts to an end user. Embodiments provide a sales forecasting system implemented on an integrated business platform that is stored in an in-memory database. The sales forecasting system uses integrated predictive and statistical methods to evaluate the reliability of the forecast. The sales forecasting system may perform a statistical analysis to derive a sequence for the influencing attributes, driving sales success in the past, and display the attributes to an end user in a specific sequence. The sales forecasting system may further be implemented through a sequences of stages, including a pipeline analysis stage where the system understands the situation and any possible risks, an analysis stage where the system may analyze past or external influences, and an application stage where the forecasting system applies the insights to a current pipeline and provides a determined simulation. Underlying in-memory based core calculations may allow for the derivation of calculated data when the data is accessed, to provide further beneficial data for the end user.

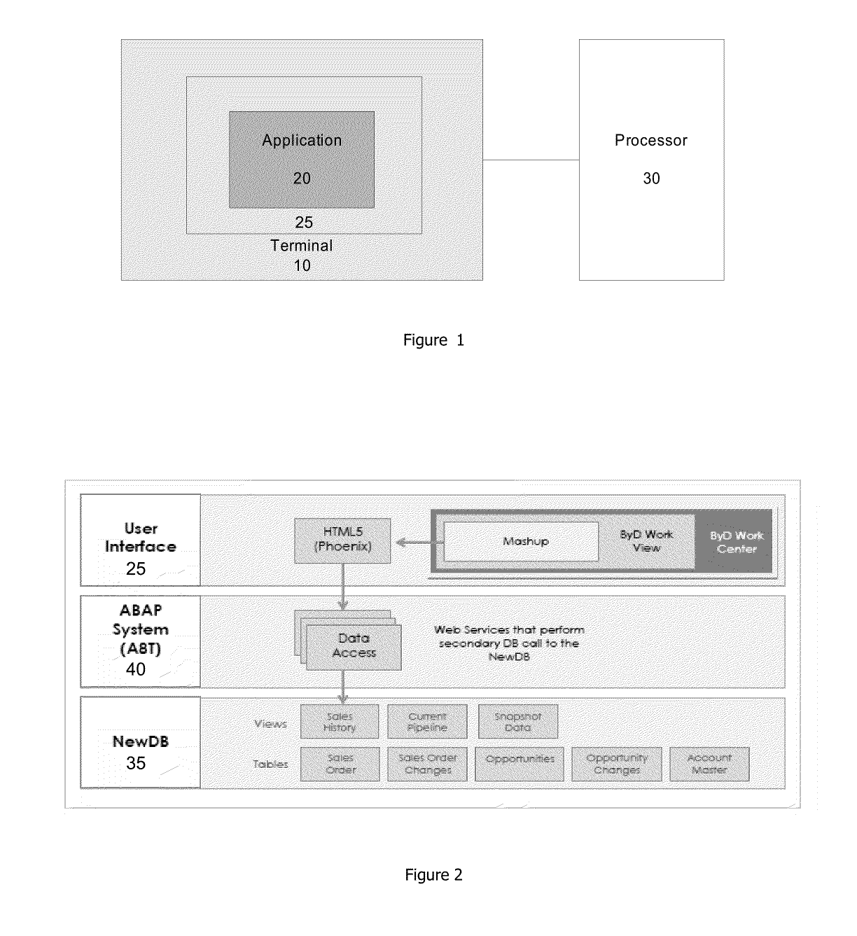

FIG. 1 illustrates a diagram of a user terminal 10 displaying the sales forecasting application 20 on the terminal. Application 20 may be executed, for example, by a processor 30 and may be displayed on a user interface 25 of user terminal 10 to a user. In an embodiment, application 20 may be provided on an integrated business platform and stored in a main memory database of a computing device. In an embodiment, the integrated business platform may be SAP Business ByDesign™. User terminal 10 may be embodied, for example, as a desktop, laptop, notebook, or other computing device. In other embodiments, user terminal 10 may be a hand-held device, personal digital assistant (PDA), television set-top Internet appliance, mobile telephone, smart phone, iPod™, iPhone™, iPad™, etc., or as a combination of one or more thereof, or other comparable device.

In an example embodiment, application 20 may be an application that is implemented on a back end component and displayed on a user interface on user terminal 10. In another embodiment, the application may be a computer-based application stored in the main memory database of user terminal 10.

In an example embodiment, the system and method may include one or more processors 30, which may be implemented using any conventional processing circuit and device or combination thereof, e.g., a central processing unit (CPU) of a personal computer (PC) or other workstation processor, to execute code provided, to perform any of the methods described herein, alone or in combination. In an embodiment, the executed code may be stored in a main memory database of user terminal 10. In this example embodiment, the main memory database may be an in-memory database such as SAP HANA™, where data is stored in the main memory (RAM).

FIG. 2 illustrates a diagram of the architecture of the sales forecasting application and system according to an embodiment. In an embodiment, the sales forecasting system may be viewed on a user terminal 10 and communicate with a back end system. In the architecture depicted in FIG. 2, the sales forecasting system may include a database 35. In an embodiment, database 35 may be an in-memory database. Database 35 may be loaded with, and subsequently store, data such as customer data, sales orders, change data, opportunity data, and any master data. Data may be extracted from a plurality of productive systems and pushed into database 35. Examples of relevant data that may be stored in database 35 may include, as depicted in FIG. 2, “Sales Orders” “Sales Order Changes” “Opportunities”, “Opportunity Changes”, and “Account Master”. This data may be presented in tables, for example, to be retrieved from database 35. In an example embodiment, this data may be modeled through HANA modeling using HANA Studio™ and uploaded to database 35 via a file transfer.

Database 35 may also include data, for example, pertaining to “Sales History”, “Current Pipeline”, and “Snapshot Data”, which may provide data that may be viewed in a graphical manner by an end user. It should be understood that the examples of stored data as illustrated in FIG. 2 does not represent an exhaustive list of all data that may be stored in database 35.

The sales forecasting application 20 may be displayed on an a user interface 25. User interface 25 may be designed specifically to provide an interaction flow to allow for combining the analytics on the retrieved data with visualizations derived from the retrieved data. In an embodiment, user interface 25 may be configured to display the integrated business platform such as SAP Business ByDesign™. The layout of the user interface 25 may be written in a plurality of programming languages. In an example embodiment, as illustrated in FIG. 2, an html language such as html5 may be used to design the user interface 25.

In an embodiment, data may be directly accessed from database 35 by the application. In another embodiment, the data from database 35 may be accessed using an advanced business application programming (ABAP) system 40. ABAP system 40 may be a web-based service defined in an internet communication frame work and may issue a secondary database call to database 35 to access the stored data.

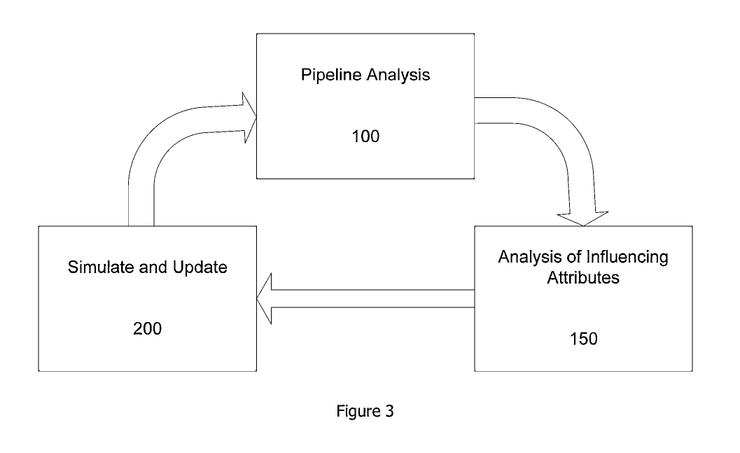

FIG. 3 illustrates a flow diagram of the process stages of the sales forecasting application 20 according to an embodiment. The sales forecasting application 20 may include a first stage 100 where pipeline analysis of historical data is performed to generate a current pipeline, a second stage 200 where analysis of the influencing attributes is performed, and a third stage 300 where a simulation of a forecast is done and the current pipeline is updated.

In a first stage 100, a pipeline analysis may be performed on existing historical data that may be stored in the in-memory database 35. This may provide a user with graphical and textual information in regards to previous sales, etc., which may be displayed to the user on user interface 25.

In pipeline analysis stage 100, all related historical and process information is delivered from analytical data sources, for example database 35 as depicted in FIG. 2, to the forecasting application 20. The master data, such as customer data, or underlying business objects, such as opportunity data, may be retrieved from the data sources and may be displayed in fields, for example, extension fields, in user interface 25. Retrieved data may include available change data for sales orders and opportunities in order to analyze the development of the sales pipeline across time. Data retrieved from the data sources may depend on the spectrum of information which is stored, for example, in database 35. In an embodiment, database 35 may also include information pertaining to opportunities, customer attributes, as well as any contextual or behavior information, as illustrated in FIG. 2.

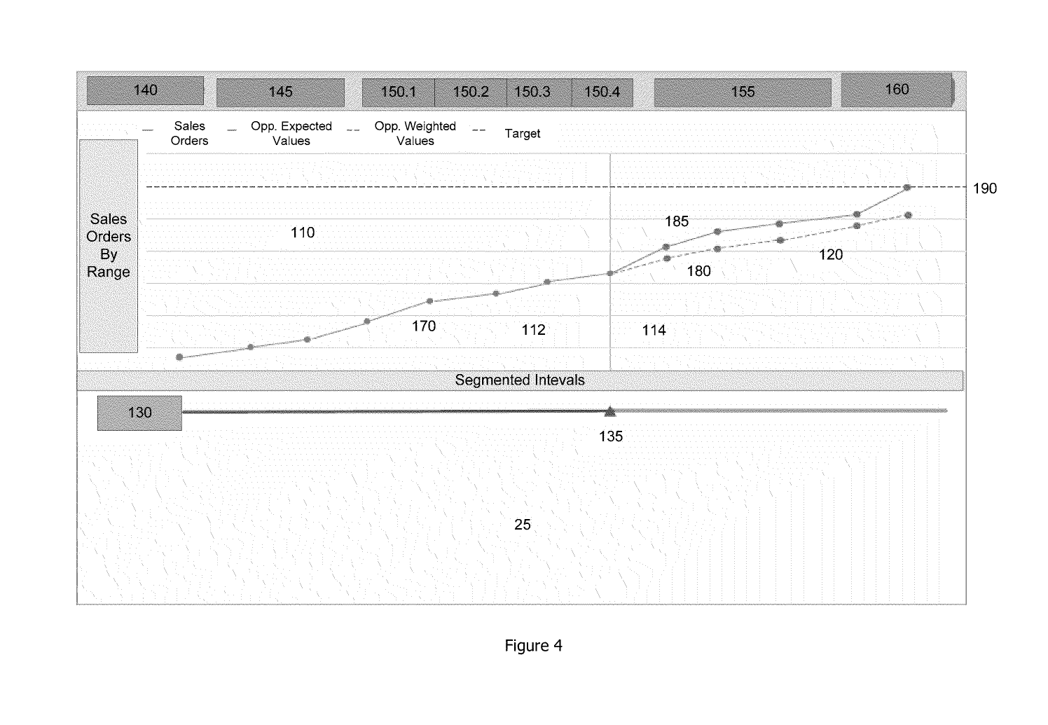

In the pipeline analysis stage 100, after the retrieval of the relevant data, a complete and up-to-date picture of a current pipeline, such as existing sales orders for a particular customer, may be presented to an end user in user interface 25. This may be depicted, for example, by line graph 170 in FIG. 4. In an embodiment, the user interface 25 may also display the achievement of any sales targets, as well as the achievement of sales targets.

FIG. 4 illustrates a diagram of the sales forecasting application 20 displayed on user interface 25 during a pipeline analysis according to an embodiment. As depicted in FIG. 4, the pipeline analysis stage 100 may be displayed on a viewing pane in user interface 25 to an end user. The viewing pane in user interface 25 may include a graphical display in which retrieved data is displayed to the user to present an overview of the current state (pipeline), for example, of sales. In the embodiment illustrated in FIG. 4, sales orders may be displayed in the viewing pane of the user interface 25. This information may be plotted graphically, for example, as a line graph, as depicted in FIG. 4. In other embodiments, the information may be plotted as a bar graph or other type of graph. In the example embodiment in FIG. 4, sales orders may be plotted in a graphical display 110 in the viewing pane of user interface 25. In other embodiments, other types of relevant data may be plotted in graphical display 110.

In the embodiment in FIG. 4, the sales orders at specific time periods over a designated period of time may be presented in graphical display 110. The y-axis of graphical display 110 may correspond to a range of sales orders by units. In an embodiment, a user may select the ranges of sales orders and designated intervals. Each line interval in graphical display 110 may correspond to, for example, 100,000 units of sales. The x-axis of graphical display 110 may correspond to selected time intervals over a designated period of time. In an embodiment, each unit on the x-axis of graphical display 110 may correspond to a subsequent sales week or quarter. An end user may select the display intervals for graphical display 110 by clicking buttons 150.1-150.4.

The viewing pane of user interface 25 may include a selecting bar 130 that is situated below the graphical display 110. This selecting bar 130 may allow for a user to identify and select a specific time. An end user may select and drag icon 135 across selecting bar 130 to a specific time in graphical display 110. In an example embodiment where an end user has selected to view sales orders by sales weeks, icon 135 may be selectably controlled to move to a specific week.

The graphical display 110 in the viewing pane of the user interface 25 may be made up multiple areas. A first area 112 may correspond to historical data, particularly historical sales data such as completed sales orders. In an embodiment, the first area 112 may correspond to historic data before a designated week as selected by icon 135 in selecting bar 130. A line graph 170 may be plotted in area 112 to correspond to the historical data. In the embodiment in FIG. 4, line graph 170 may correspond to completed sales orders prior to a week designated by icon 135. Line graph 170 may correspond to a current pipeline representing previous and current sales orders prior to a selected date.

A second area 114 may correspond to predicted opportunities, particularly opportunities for future sales orders. The display of the opportunity pipeline line graphs 180 and 185 may occur in stage 300 after the opportunity pipelines have been simulated. In an embodiment, the second area 114 may depict sales opportunities after a designated week (or time date) has been selected by icon 135 in selecting bar 130. Area 114 may display one or more line graphs representing future opportunity, for example, for sales orders. Line graph 185 may correspond to an expected value opportunity pipeline based on stored opportunity data in database 35. Line graph 185 may not be displayed until a simulation of the opportunity pipelines has been performed in stage 300. In an embodiment, the stored opportunity data may be marked relevant based on specific relevancies or influencing attributes. Second area 114 may also display a line graph 180 which may correspond to a weighted opportunity pipeline based on the relevant stored opportunity data in database 35 that has been designated as influencing attributes in stage 200. The data in line graph 180 may be weighted based on various relevance criteria. In an embodiment, line graph 185 may only be displayed when a simulation of the opportunity pipelines has been performed in stage 300.

Graphical display 110 may also display a target line 190. This target line 190 may represent a specific targeted goal for sales orders by the conclusion of a particular period. Target line 190 may be displayed concurrently in graphical display 110 with line graphs 170, 180, and 185.

The viewing pane of user interface 25 may also include various clickable buttons for which a user can change the display of graphical display 110. A user may selectably click on buttons 140, 145, 150.1-150.4, and 155 to control the information that is to be displayed in graphical display 110. These buttons may be displayed adjacent to each other and may be situated above graphical display 110. Clickable button 140 may correspond to a selection for the display of expected values for sales orders based on the opportunity data. A selection of button 140 may display line graph 185 in graphical display 110 after a simulation has been run in stage 300. Line graph 185 may portray expected opportunity values based on the stored opportunity data and the previous sales orders. A de-selection of button 140 may remove line graph 185 from display in graphical display 110.

Clickable button 145 may correspond to a selection for the display of weighted values for sales orders based on the opportunity data. A selection of button 145 may display line graph 180 in graphical display 110. Line graph 180 may portray weighted opportunity values based on the stored opportunity data and the previous sales orders. Line graph 185 may reflect any specific weight put on a number of influencing attributes as well as other influences. A de-selection of button 145 may remove line graph 180 from display in graphical display 110.

Clickable buttons 150.1-150.4 may be selected to change graphical display 110 to display the information over a specific time period. In an example embodiment, where sales order are plotted on a per week basis, a user may selectably click on buttons 150.1-150.4 to change the number of weeks that are displayed in graphical display 110. In an embodiment, button 150.1 may correspond to the configuration for a view of a current sales quarter. A selection of button 150.1 may configure graphical display 110 to display sales information for each of the weeks in the current quarter. Alternatively, button 150.2 may correspond to the configuration for a view of two sales quarters. A selection of button 150.2 may configure graphical display 110 to display sales information for each of the weeks in the two quarters.

Button 150.3 may correspond to the configuration for a view of sales based on a monthly basis. A selection of button 150.3 may configure graphical display 110 to display sales information for past monthly and forecasted monthly sales orders. Button 150.4 may correspond to the configuration for a view of sales based on a yearly basis. A selection of button 150.4 may configure graphical display 110 to display sales information for past yearly and forecasted yearly sales orders.

Clickable button 155 may be selected to display previous years' sales data to graphical display 110 to allow for a comparison to historical data over the same time period. A selection of clickable button 155 may display a line graph in graphical display 110 simultaneously with and adjacent to the line graphs for the current pipeline 190 and the opportunity pipelines 180 and 185. Graphical display 110 may also display the target sales line for the previously displayed year.

Clickable button 160 may correspond to a start button. The selection of button 160 may provide for the start of a simulation and analysis for the displayed pipelines in graphical display 110.

In an example embodiment, line graphs 170, 180, and 185 may be partly calculated and derived directly using in memory-technologies. The forecasted opportunity data may be computed based on, for example, the longevity of a customer relationship, the timing between sales orders, lead time between opportunity creation and deal closure, an opportunity age, and any durations between opportunity phases.

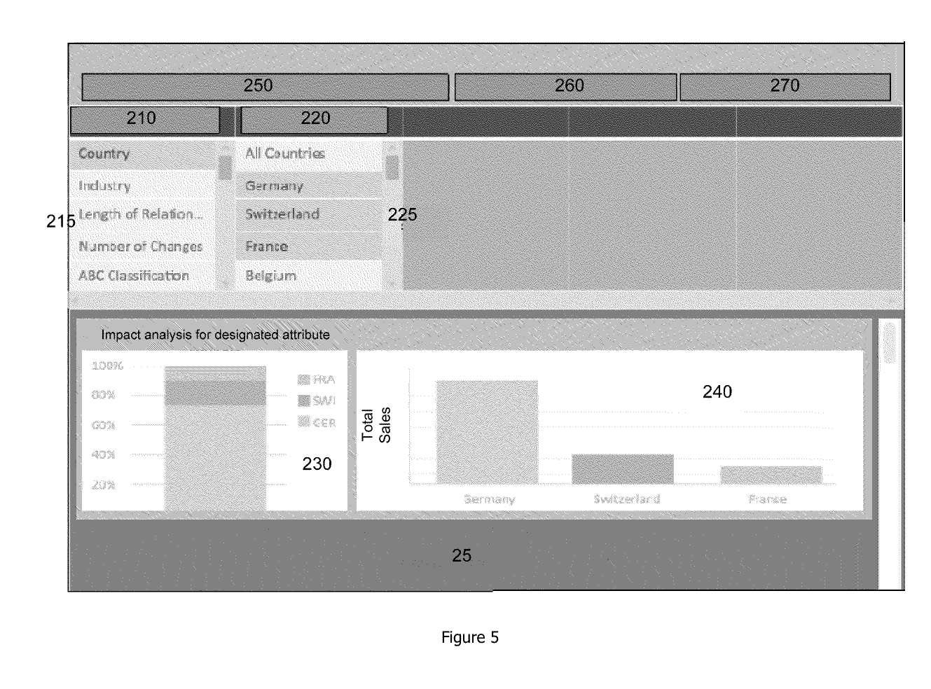

A second stage of the sales forecasting application 20 may be displayed in FIG. 5. FIG. 5 illustrates a diagram of the second stage 200 of the sales forecasting application as displayed on a user interface 25 according to an embodiment. In this second stage 200, an analysis of the influencing attributes may be performed. User interface 25 may display a viewing pane in which an analysis of the influencing attributes for historical sales orders may be displayed. In an embodiment, the viewing pane may be accessed by clicking from the pipeline analysis display. In another embodiment, the viewing pane may be accessed by opening a separate window from the current pipeline analysis display.

As illustrated in FIG. 5, the user interface 25 may display a list of influencing attributes for a specific time period. In input field 250, a user may select a period of the historical sales orders to analyze from a drop down menu. Panel 210 may display all of the influencing attributes for the period selected in input field 250. The system may provide a list of all influencing attributes after an analysis of the sales history for the designated period has been performed. These attributes may range from transactional and master data fields to fields which may be instantaneously calculated in-memory, such as the length of a relationship with a customer. These influencing attributes may be individually listed in selection field 215.

Statistical methods may be used to generate the list of influencing attributes. Highly relevant influencing attributes may be identified by measuring the data distribution and thereby the heterogeneity of data, resulting in a sorted list of influencing attributes. Measuring data distributions to generate influencing attributes is further described in co-pending U.S. patent application Ser. No. 13/546,157.

In order to focus on the most significant influencing attributes, the system may sort the attributes by relevance and display the attributes in selection field 215 based upon the sorting. In an example embodiment, the sort order as well as the subsequent interactive analysis, may be driven by the assumption that a heterogeneous distribution of revenues across different groups, for example, different industries, is critical to differentiate between successful and unsuccessful business segments.

An end user may scroll through the list of influencing attributes or attributes in selection field 215 via a scroll bar to view the list of influencing attributes. As depicted in FIG. 5, examples of influencing attributes may include, but are not restricted to, “Country” (the country where customers who placed orders were located), “Industry” (pertaining to the specific industry in which the sale was made), “Length of Relationship” (how long a purchasing customer has been a customer), “Number of Changes”, and “ABC Classification”. A selection of an attribute from selection field 215, may generate a second panel 220. In panel 220, a user may select a attribute value in selection field 225. In an example embodiment, as depicted in FIG. 5, where a user selected “Country” from the list of influencing attributes, a list of countries from which sales occurred may be sorted and displayed in selection field 225.

In selection field 225, a user may select to perform an analysis of one or more attribute values. This may occur through the selection of multiple attributes in selection field 225. A user may scroll through the list of attribute values in selection field 215 via a scroll bar and click on one or more attribute values. In the example embodiment depicted in FIG. 5, where a user selected “Country” from the list of influencing attributes, a user may select specific countries to compare or may select to compare all countries in which sales were made by selecting “All Countries”.

The selection of the attribute value(s) in selection field 225 may generate a number of figures which may provide for a comparison of the attribute values. A zebra chart may be displayed in panel 230. This zebra chart may graphically display a segmented comparison of the relative shares of each attribute value, as percentage, of success of the sales orders. In panel 240, a bar graph may be displayed comparing the attribute values. The bar graph in panel 240 may, for example, graphically display the absolute contribute that each of the further limiting attributes to total revenue. In another embodiment, a graphic display may be generated depicted the growth rate for each of the attribute values.

A user can interactively review the different influencing attributes and study the related distributions, statistical measures, and business trends provided by the generated figures. Clickable button 260 may generate a new window in which a user may determine a segmentation of the influencing attributes and determine a confidence level of the current pipeline. Determining confidence levels of the various opportunity segments is further described in co-pending U.S. patent application Ser. No. 13/546,357.

A user may select clickable button 270 in the viewing pane of user interface 25 to simulate an opportunity pipeline based on any selected attributes. This simulation may represent the third stage 300 the sales forecasting application. The selection of the simulation of the opportunity pipelines may generate simulation results in a graphical display in the viewing pane of the influencing attributes window. In another embodiment, a simulation of the opportunity pipelines may result in the display of the opportunity pipelines, line graphs 180 and 185, in graphical display 110 of the pipeline analysis. A simulation of the opportunity pipelines may also result in a display of the opportunity pipelines in a graphical manner in which the opportunity pipelines are further broken down into segments depicted the confidence levels of the opportunities. This concept is further described in co-pending U.S. patent application Ser. No. 13/546,357.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the sprit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

1. A method for improving reliability of sales forecasting, the method comprising:
generating a current pipeline based on historical data retrieved from an in-memory database, wherein the in-memory database is primarily stored in Random Access Memory (RAM);
determining a list of influencing attributes based on the current pipeline and retrieved historical data, the influencing attributes being sorted by statistical relevance, wherein the determining the list of influencing attributes is performed by a processor;
displaying the sorted influencing attributes in a user interface of a user terminal, at least one attribute value of the sorted influencing attributes being selectably compared to determine future opportunities;
generating at least one opportunity pipeline, the at least one opportunity pipeline being a function of opportunity data and the influencing attributes, wherein generating the at least one opportunity pipeline includes:
determining a past opportunities portion of the at least one opportunity pipeline based on the historical data,
determining a non-weighted future opportunities portion of the at least one opportunity pipeline based on the historical data, and
determining a weighted future opportunities portion of the at least one opportunity pipeline based on weighted influencing attributes applied to the historical data; and
displaying the at least one opportunity pipeline including at least one of the past opportunities portion, the non-weighted future opportunities portion, and the weighted future opportunities portion.

2. The method according to claim 1, further comprising:
generating a list of attribute values from a selected influencing attribute.

3. The method according to claim 1, further comprising:
displaying the current pipeline over a designated time period, the designated time period being one of a month, a sales quarter, multiple sales quarters, or a year.

4. The method according to claim 1, wherein the opportunity data is stored in the in-memory database.

5. The method according to claim 1, wherein some of the influencing attributes are calculated instantaneously after the historical data is retrieved from the in-memory database.

6. The method according to claim 1, wherein the opportunity pipeline includes an expected value opportunity.

7. The method according to claim 1, wherein the opportunity pipeline includes a weighted opportunity.

8. The method according to claim 1, further comprising:
extracting the historical and opportunity data from a plurality of subsystems and loading the extracted data into the in-memory database.

9. The method according to claim 2, further comprising:
upon a user selection of the at least one attribute value from the list of attribute values, displaying at least one generated graphical display comparing the at least one attribute value to another selected attribute value.

10. A forecasting system for providing interactive sales forecasts, the system comprising:
at least one user terminal displaying a user interface, the sales forecasting system displayed on the user interface;
an in-memory database storing historical data and opportunity data, wherein the in-memory database is primarily stored in Random Access Memory (RAM); and a processor operable to:
retrieve the historical data from the in-memory database;
generate a current pipeline based on the retrieved historical data;
determine a list of influencing attributes based on the current pipeline and retrieved historical data, the influencing attributes being sorted by statistical relevance;
display the sorted influencing attributes in a user interface of a user terminal, at least one attribute value of the sorted influencing attributes being selectably compared to determine future opportunities; and
generate at least one opportunity pipeline, the at least one opportunity pipeline being a function of opportunity data and the influencing attributes, wherein to generate the at least one opportunity pipeline, the processor is further configured to:
determine a past opportunities portion of the at least one opportunity pipeline based on the historical data,
determine a non-weighted future opportunities portion of the at least one opportunity pipeline based on the historical data, and
determine a weighted future opportunities portion of the at least one opportunity pipeline based on weighted influencing attributes applied to the historical data; and
display the at least one opportunity pipeline including at least one of the past opportunities portion, the non-weighted future opportunities portion, and the weighted future opportunities portion.

11. The system according to claim 10, further comprising:
an advanced business application programming (ABAP) system to access the stored historical and opportunity data from the in-memory database.

12. The system according to claim 10, wherein the sales forecasting system is implemented on an integrated business platform.

13. The system according to claim 10, wherein a list of attribute values is generated from a selected influencing attribute.

14. The system according to claim 10, wherein the current pipeline is displayed over a designated time period, the designated time period being one of a month, a sales quarter, multiple sales quarters, or a year.

15. The system according to claim 10, wherein some of the influencing attributes are calculated instantaneously after the historical data is retrieved from the in-memory database.

16. The system according to claim 10, wherein the historical and opportunity data is extracted from a plurality of subsystems and loading the extracted data into the in-memory database.

17. The system according to claim 10, wherein upon a user selection of the at least one attribute value from the list of attribute values, at least one generated graphical display is displayed comparing the at least one attribute value to another selected attribute value.

18. (canceled)

19. A method for providing sales forecasts based on sales opportunities data and previous sales orders, the method comprising:
extracting the previous sales orders and sales opportunities data from a plurality of subsystems;
loading the extracted data into the in-memory database;
generating a current pipeline based on the previous sales orders;
determining a list of influencing attributes based on the current pipeline and the previous sales orders;
sorting the influencing attributes by a statistical relevance;
generating a list of attribute values from a selected influencing attribute;
selectably comparing at least one of attribute value of the selected influencing attribute;
displaying the compared attribute values in at least one graphical representation in a user interface of a user terminal to determine future opportunities; and
generating at least one opportunity pipeline that is displayed in the user interface, the at least one opportunity pipeline being a function of opportunity data and the influencing attributes and being displayed in the user interface over a designated time period.

20. The method according to claim 1, wherein some of the influencing attributes are calculated instantaneously after the previous sales orders are retrieved from the in-memory database.

21. A non-transitory computer-readable medium embodied with computer-executable instructions for causing a computer to execute instructions, the computer instructions comprising:
generating a current pipeline based on historical data retrieved from an in-memory database, wherein the in-memory database is primarily stored in Random Access Memory (RAM);
determining a list of influencing attributes based on the current pipeline and retrieved historical data, the influencing attributes being sorted by statistical relevance, wherein the determining the list of influencing attributes is performed by a processor;
displaying the sorted influencing attributes in a user interface of a user terminal, at least one attribute value of the sorted influencing attributes being selectably compared to determine future opportunities;
generating at least one opportunity pipeline, the at least one opportunity pipeline being a function of opportunity data and the influencing attributes, wherein generating the at least one opportunity pipeline includes:
determining a past opportunities portion of the at least one opportunity pipeline based on the historical data,
determining a non-weighted future opportunities portion of the at least one opportunity pipeline based on the historical data, and
determining a weighted future opportunities portion of the at least one opportunity pipeline based on weighted influencing attributes applied to the historical data; and
displaying the at least one opportunity pipeline including at least one of the past opportunities portion, the non-weighted future opportunities portion, and the weighted future opportunities portion.
